(19) United States
(12) Patent Application Publication
(10) Pub. No.: US 2005/0160274 A1
(43) Pub. Date: Jul. 21, 2005

(54) Content transmission apparatus and content reception apparatus

(76) Inventors: Takanori Yukimatsu, Yokohama (JP); Hiroo Okamoto, Yokohama (JP); Yoshimichi Kudo, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/846,594

(22) Filed: May 17, 2004

(30) Foreign Application Priority Data
Jan. 16, 2004 (JP) 2004-008622

(51) Int. Cl. B41J 1/00

(52) U.S. Cl. 713/182; 713/168

(57) ABSTRACT

It is an object of the present invention to protect a copyright of a content by suppressing creation of illegal copies of the content and prevent a content from being transmitted beyond a range of personal use in a process to transmit the content through a wire or wireless LAN. Before transmitting a content from a content transmission apparatus to a content reception apparatus, the content transmission apparatus and the content reception apparatus authenticate each other. In the authentication, a timer measures a time interval between a transmission of an authentication request and a reception of an acknowledgement of a reception of the request or between a transmission of a response to a received authentication request and a reception of an acknowledgement of a reception of the response. If the time interval does not exceed an upper limit, a content encrypted by using a shared key is transmitted from the content transmission apparatus to the content reception apparatus, and the address of the content reception apparatus as well as apparatus information unique to the content reception apparatus are cataloged in the content transmission apparatus. Thus, in order to transmit another content, the content is merely encrypted prior to the transmission without measuring a time interval.

### CLAIM OF PRIORITY

The present application claims priority from Japanese application serial no. P2004-008622, filed on Jan. 16, 2004, the content of which is hereby incorporated by reference into this application.

### BACKGROUND OF THE INVENTION

The present invention relates to a content transmission apparatus and a content reception apparatus, which are suitable for protecting copyrights of typically video and audio contents transmitted and received thereby through a network.

With improvement of the processing power of the personal computer, which is abbreviated hereafter to the PC, the storage capacity,of a hard-disk drive (abbreviated hereafter to an HDD) embedded in the PC also increases as well. By the processing power of a PC, the processing speed and storage capacity of the PC are implied. In this situation, even a PC of a rank intended for an ordinary home can be used for recording a TV broadcast program in the HDD to be watched later through a display unit of the PC. In addition, with the decreasing price of the HDD having a large storage capacity, an HDD video-recording apparatus having such an HDD embedded therein has been introduced also as a home video-recording apparatus for digitally recording audio/video information, and the fact that the user can utilize such a video-recording apparatus with a high degree of convenience by making use of a disk as a recording medium attracts much attention.

In recording equipment such as a video-recording apparatus and a PC, which employ the HDD described above, audio/video information can be recorded in an HDD fixed in the recording equipment in a room of a home. Thus, if the user wants to watch the recorded information in another room of the home, the user must move the recording equipment itself to the other room. That is to say, it is difficult to implement an application in which a plurality of video-recording/reproduction apparatus employing a replaceable recording medium is provided and the audio/video medium is moved from a video-recording/reproduction apparatus installed in a room to another apparatus installed in another room. An example of the video-recording/reproduction apparatus employing a replaceable recording medium is a VTR.

In order to solve the problem described above, there has been conceived a solution in which a video-recording apparatus is provided with an interface with a wire or wireless LAN (Local Area Network) and, by transmitting audio/video information recorded at a room of a home from the video-recording apparatus to another PC or reception apparatus installed at any other room of the home by way of the network, the user can watch the recorded information in the other room.

By the way, in order to protect copyrights of information such as contents, a Digital Transmission Content Protection (DTCP) has been provided as a typical copy protection method incorporated in a digital AV apparatus. The DTCP defines a copy protection method on an IEEE1394 bus or the like. For more information on the DTCP, refer to non-patent reference 1, namely, the 5C Digital Transmission Content Protection White Paper authored by Hitachi Ltd. et cetera.

In addition, some technologies have been developed as technologies for implementing copy protection to protect copyrights in the course of transmission between apparatus or transmission through a network. Such technologies are disclosed in documents such as Japanese Patent Laid-open No. 2000-287192 referred to hereafter as patent reference 1 and Japanese Patent Laid-open No. 2001-358706 referred to hereafter as patent reference 2.

### SUMMARY OF THE INVENTION

In accordance with the conventional technologies described above, a video-recording apparatus for home applications is provided with an interface with a wire or wireless LAN (Local Area Network) and, by transmitting audio/video information recorded in the video-recording apparatus located in a room of a home from the video-recording apparatus to another PC or reception apparatus installed in any other room of the home by way of the network, the user can watch the recorded information in the other room. However, the conventional technologies do not consider copyright protection of audio/video information, the copyrights of which should be protected. In the following description, the audio/video information deserving copy protection is referred to as a content. Audio/video information recorded in an HDD of the video-recording apparatus can be transmitted to another PC by way of a LAN and stored in the HDD of the other PC. Thus, the audio/video information handled in this way must be a copy-free content, which can be copied with complete freedom.

In general, when a digitally recorded content is transmitted from one apparatus to another by way of a network or the like to be recorded in the other apparatus as described above, the data quality of the content hardly deteriorates in the course of the transmission. That is to say, in the apparatus on the reception side, it is possible to generate a copy of a content as a copy with the same quality as the content recorded in the apparatus on the transmission side. It is thus necessary to consider prevention of audio and video data from being created by illegal copying beyond a range of personal use. The audio and video data, the copyright of which should be protected, is referred to hereafter as a content. In a transmission of a content between digital AV apparatus, for example, the apparatus on the content transmission side encrypts the content and, by letting only the apparatus on the content transmission side and the apparatus on the content reception side share information for encrypting the content and decrypting the encrypted content, an apparatus other than the content reception apparatus serving as the sole transmission target of the content is not capable of correctly decrypting the content received from the apparatus on the content transmission side. In this way, it is possible to implement copy protection for avoiding creation of a limitless number of copies.

As a typical example of such a copy protection method adopted in digital AV apparatus, the DTCP method disclosed in non-patent reference 1 is provided. In accordance with the DTCP method, contents are managed by classifying the contents into ‘Copy free’, ‘Copy one generation’, ‘No more copies’ and ‘Copy never’ categories. In a video-recording apparatus, only contents of the ‘Copy free’ and ‘Copy one generation’ categories are recorded. A content of the ‘Copy one generation’ category can be recorded only once and, after being recorded, the content is handled as a content of the ‘No more copies’ category. Except a content of the ‘Copy free’ category, any content is encrypted in the apparatus on the transmission side prior to a transmission to an apparatus on the reception side so as to prevent a limitless number of copies from being created from the content.

Some technologies have been disclosed as technologies for implementing copy protection for protecting the copyright of a content in a transmission of the content by way of a wire or wireless LAN on the basis of a concept similar to the DTCP method. For example, patent reference 1 discloses a technology applying a technique similar to the DTCP to copy protection for distribution of a content through a network. On the other hand, patent reference 2 discloses a technology of building inter-apparatus communications by encryption also for protection of copyrights of contents.

In accordance with these technologies, a content is transmitted from an apparatus on the transmission side to an apparatus on the reception side by way of a wire or wireless network by not considering whether or not the apparatus on the transmission side and the apparatus on the reception side are installed at the same home. Rather, in the case of downloading a content from a distribution server, in general, the apparatus on the transmission side is located at the site of the provider and the apparatus on the reception side is located at an ordinary home.

Thus, even though the technologies described above are applied solely to a case in which a content is recorded in an HDD of a PC or an HDD embedded in a video-recording apparatus and then transmitted to another apparatus installed at the same home by way of a LAN provided at the home, a reception apparatus installed at another home connected to the LAN through the Internet is capable of receiving and displaying the content. In addition, the transmission range of the content can be widened to all places in the world provided that the places are connected to the Internet.

Assume that the user of a video-recording apparatus puts the video-recording apparatus in a state of being accessible from the Internet in such a situation. In this case, even if copy protection is applied in accordance with the technologies described above, a reception apparatus will be capable of receiving a content from the video-recording apparatus by way of the Internet with a high degree of freedom and displaying the content, provided that the reception apparatus has the copy-protect function. Thus, such a reception apparatus is capable of substantially departing from a range of personal use, which is the original purpose of the copyright protection.

It is thus an object of the present invention to provide a content/information transmission apparatus, a content/information reception apparatus and a content/information transmission method, which are capable of implementing copy protection for avoiding an illegal operation to copy a content during a transmission of the content through a wire or wireless LAN installed at a home and capable of limiting legal operations to watch a content and make copies of the content to a range of personal use of the content.

In order to solve the problems described above, the present invention provides a content transmission apparatus for transmitting a content to a content reception apparatus by way of a network as a content transmission apparatus comprising:
a network communication process means for transmitting and receiving data by way of the network;
a transmission-content generation means for supplying a content to be transmitted to the content reception apparatus, which is connected to the content transmission apparatus through the network, to the network communication process means;
an authentication means for receiving an authentication request from the content reception apparatus, carrying out an authentication determination for the received authentication request and issuing its own authentication request to the content reception apparatus;
an encryption means for generating a key based on information produced by the authentication means as a result of execution of an authentication process in the authentication means and encrypting a content to be transmitted to the content reception apparatus by using the key;
a timer means (a time measurement means) used if necessary for measuring a time interval between a transmission of its own authentication request to the content reception apparatus and a reception of an acknowledgement of a reception of the authentication request from the content reception apparatus or between a transmission of a response to an authentication request received from the content reception apparatus to the content reception apparatus and a reception of an acknowledgement of a reception of the response from the content reception apparatus; and
an apparatus-information management means for cataloging and managing apparatus information of the content reception apparatus;
wherein the apparatus-information management means controls operations to catalog the address of the content reception apparatus and apparatus information stored in advance at an apparatus-manufacturing time as information unique to the content reception apparatus in dependence on a measurement result produced by the timer means.

To be more specific, if the measurement result produced by the timer means does not exceed a predetermined value at the timer means, the address of the content reception apparatus and the apparatus information unique to the content reception apparatus are stored in the apparatus-information management means.

In addition, when a request for a content is received from the content reception apparatus, an address and apparatus-unique information, which have been cataloged in the apparatus-information management means, are compared with the address of the content reception apparatus and apparatus information unique to the content reception apparatus respectively and, if they match each other, the requested content is transmitted to the content reception apparatus without driving the timer means to measure a time interval.

Furthermore, in order to solve the problems described above, the present invention provides a content reception apparatus for receiving a content transmitted from a content transmission apparatus by way of a network as a content reception apparatus comprising:
a network communication process means for transmitting and receiving data by way of the network;
a content reception process means for receiving a content from the network communication process means receiving the content from the content transmission apparatus connected to the content reception apparatus through the network;
an authentication means for issuing an authentication request to the content transmission means and carrying out an authentication determination for an authentication request received from the content transmission apparatus;
an encryption means for generating a key based on information produced by the authentication means as a result of execution of an authentication process in the authentication means and decrypting an encrypted content received from the content transmission apparatus by using the key;
a timer means used if necessary for measuring a time interval between a transmission of an authentication request to the content transmission apparatus and a reception of an acknowledgement of a reception of the authentication request from the content transmission apparatus or between a transmission of a response to an authentication request received from the content transmission apparatus to the content reception apparatus and a reception of an acknowledgement of a reception of the response from the content transmission apparatus; and
an apparatus-information management means for cataloging and managing apparatus information of the content transmission apparatus;
wherein the apparatus-information management means controls operations to catalog the address of the content transmission means and apparatus information stored in advance at an apparatus-manufacturing time as information unique to the content transmission apparatus in dependence on a measurement result produced by the timer means.

That is to say, in accordance with the present invention, the content transmission apparatus and the content reception apparatus authenticate each other prior to a transmission of a content. When the authentications are carried out, the timer means each measure a time interval between a transmission of an authentication request and a reception of an acknowledgement of a reception of the authentication request or between a transmission of a response to an authentication request and a reception of an acknowledgement of a reception of the response. Only if the measured time intervals do not exceed the predetermined values, a content encrypted by using a shared key is transmitted. In addition, an address and apparatus-unique information are cataloged for the content reception apparatus. Thus, in an operation to again transmit a content to the content reception apparatus, the content is merely encrypted prior to the transmission without driving the timer means to measure a time interval.

As a result, it is possible to implement copy protection for avoiding illegal copies of a content transmitted by way of a wire or wireless LAN installed at a home. In addition, it is also possible to limit legal operations to watch a content and make copies of the content to a range of personal use of the content.

In accordance with the present invention, it is possible to improve the reliabilities of the content transmission apparatus, the content reception apparatus and the content transmission, which utilize a wire or wireless LAN installed at a home.

### BRIEF DESCRIPTION OF THE DRAWINGS

FIG. 1 is a diagram showing a configuration in which a content transmission apparatus and a content reception apparatus, which are implemented by an embodiment of the present invention, are connected to each other by using a wire LAN;

FIG. 2 is a block diagram showing a wire LAN for connecting content reception apparatus and a content transmission apparatus, which are implemented by an embodiment of the present invention;

FIG. 3 is a diagram showing an apparatus-information registration circuit employed in a content transmission apparatus implemented by an embodiment of the present invention;

FIG. 4 is a diagram showing a list cataloged in the apparatus-information registration circuit employed in a content transmission apparatus implemented by an embodiment of the present invention;

FIG. 5 is a diagram showing a procedure for transmitting a content between a content transmission apparatus and a content reception apparatus, which are implemented by an embodiment of the present invention;

FIG. 6 is a diagram showing a procedure adopted by a content transmission apparatus and a content reception apparatus, which are implemented by an embodiment of the present invention, for measuring a time interval securely and accurately;

FIG. 7 is a diagram showing a configuration in which a content is transmitted between a content transmission apparatus and a content reception apparatus, which are implemented by an embodiment of the present invention;

FIG. 8 is a diagram showing a configuration in which a content transmission apparatus and a content reception apparatus, which are implemented by an embodiment of the present invention, are connected to each other by using a wireless LAN;

FIG. 9 is a block diagram showing a wireless LAN for connecting content reception apparatus and a content transmission apparatus, which are implemented by an embodiment of the present invention; and

FIG. 10 is a diagram showing a typical configuration including a PDA implemented by an embodiment of the present invention.

### DESCRIPTION OF THE PREFERRED EMBODIMENTS

Preferred embodiments of the present invention are explained by referring to diagrams as follows.

### First Embodiment

A first embodiment of the present invention is explained as follows.

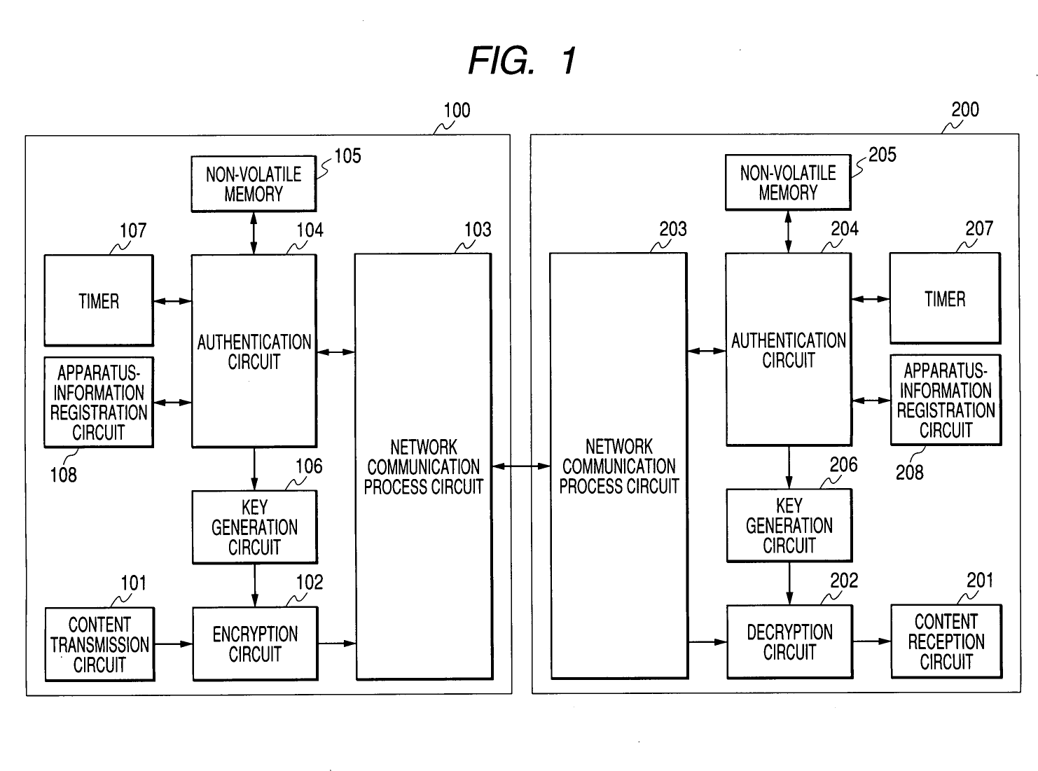

FIG. 1 is a diagram showing a configuration including a content transmission apparatus 100 and a content reception apparatus 200, which are implemented by a first embodiment of the present invention. In the configuration, the content transmission apparatus 100 and the content reception apparatus 200 are connected to each other by using a LAN. The content transmission apparatus 100 comprises a content transmission circuit 101, an encryption circuit 102, a network-communication process circuit 103, an authentication circuit 104, a non-volatile memory 105, a key generation circuit 106, a timer circuit 107 and an apparatus-information registration circuit 108. The content transmission circuit 101 is a circuit for generating a content to be transmitted to the content reception apparatus 200. The encryption circuit 102 is a circuit for encrypting a content output by the content transmission circuit 101. The network-communication process circuit 103 is a circuit for transmitting a content encrypted by the encryption circuit 102 and an output of the authentication circuit 104 to another apparatus and receiving an input to the authentication circuit 104 from another apparatus by way of the LAN. The authentication circuit 104 is a circuit for exchanging information with another apparatus, which is connected to the LAN, to authenticate the other apparatus and request the other apparatus to authenticate the content transmission apparatus 100. The non-volatile memory 105 is a memory used for storing information necessary for processing carried out by the authentication circuit 104. The key generation circuit 106 is a circuit for generating a key based on information generated by the authentication circuit 104 as a key to be used by the encryption circuit 102 to encrypt a content. The timer circuit 107 is a circuit for measuring a time interval between a transmission of information such as an authentication request issued by the authentication circuit 104 to another apparatus and a reception of an acknowledgement of a reception of the information from the other apparatus. The apparatus-information registration circuit 108 is a circuit for cataloging apparatus information of another apparatus authenticated by the authentication circuit 104 and managing the cataloged apparatus information. An identification code is appended to a content transmitted by the content transmission circuit 101 to the content reception apparatus 200. The identification code appended to a content can be ‘Copy free’, ‘Copy one generation’, ‘No more copies’ or ‘Copy never’ indicating how to handle the content.

On the other hand, the content reception apparatus 200 comprises a content reception circuit 201, a decryption circuit 202, a network-communication process circuit 203, an authentication circuit 204, a non-volatile memory 205, a key generation circuit 206, a timer circuit 207 and an apparatus-information registration circuit 208. The content reception circuit 201 is a circuit for receiving a content transmitted by another apparatus by way of the LAN. The decryption circuit 202 is a circuit for finally receiving a content encrypted by the encryption circuit 102 employed in the content transmission apparatus 100 from the network-communication process circuit 203, decrypting the content and outputting the decrypted content to the content reception circuit 201. The network-communication process circuit 203 is a circuit for transmitting an output of the authentication circuit 204 to another apparatus and receiving an input to the authentication circuit 204 and a content supplied to the decryption circuit 202 from another apparatus by way of the LAN. The authentication circuit 204 is a circuit for exchanging information with another apparatus to authenticate the other apparatus and request the other apparatus to authenticate the content reception apparatus 200. The non-volatile memory 205 is a memory used for storing information necessary for processing carried out by the authentication circuit 204. The key generation circuit 206 is a circuit for generating a key based on information generated by the authentication circuit 204 as a key to be used by the decryption circuit 202 to decrypt a content. The timer circuit 207 is a circuit for measuring a time interval between a transmission of information such as an authentication request issued by the authentication circuit 204 to another apparatus and a reception of an acknowledgement of a reception of the information from the other apparatus. The apparatus-information registration circuit 208 is a circuit for cataloging apparatus information of another apparatus authenticated by the authentication circuit 204 and managing the cataloged apparatus information. An identification code is received along with a content. The content is processed in accordance with an identification code received along with the content. The identification code received along with a content can be ‘Copy free’, ‘Copy one generation’, ‘No more copies’ or ‘Copy never’. In the content reception apparatus 200, only contents of the ‘Copy free’ and ‘Copy one generation’ categories are recorded. A content of the ‘Copy one generation’ category can be recorded only once and, after being recorded, the content is handled as a content of the ‘No more copies’ category.

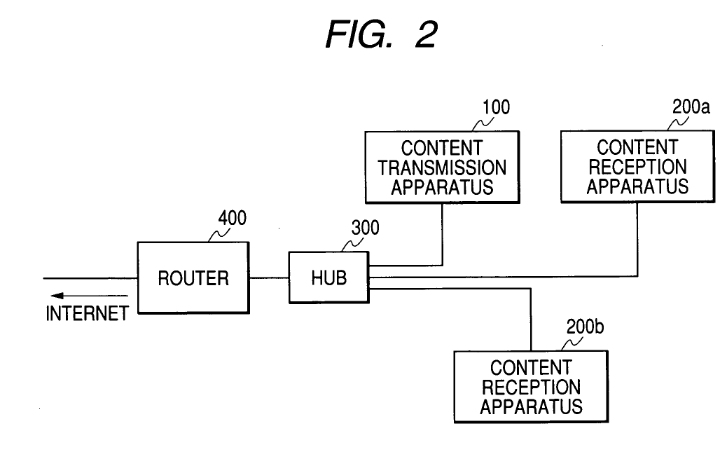

FIG. 2 is a block diagram showing the configuration of a wire LAN installed at a home as a LAN for connecting content reception apparatus 200 and a content transmission apparatus 100. To put it in detail, the content transmission apparatus 100 and the two content reception apparatus 200a and 200b are connected to a hub 300 by cables of the wire LAN. The hub 300 is connected to a router 400, which is connected to the Internet through a device such as a modem or an opto-electrical converter. The content transmission apparatus 100, the content reception apparatus 200a and 200b as well as the router 400 each has an IP address for identifying the owner of the address as an apparatus existing in the LAN. In addition, a MAC (Media Access Control) address having a length of 48 bits is assigned in advance to an interface unit of each of the network-communication process circuit 103 and the network-communication process circuit 203 at a manufacturing time.

The IP addresses are set in the content transmission apparatus 100, the content reception apparatus 200a and 200b as well as the router 400 in accordance with a DHCP (Dynamic Host Configuration Protocol) widely adopted as a conventional protocol for automatically setting addresses in a network. In accordance with the DHCP, typically, the router 400 is operated as a DHCP server, which then assigns IP addresses to the other apparatus. It is to be noted that, if an IPv6 (Internet Protocol Version 6) is used, in accordance with a method known as a stateless automatic setting technique, an IP address assigned to another apparatus consists of the 64 high-order bits of an IP address assigned to the router 400 and a MAC address set in the other apparatus.

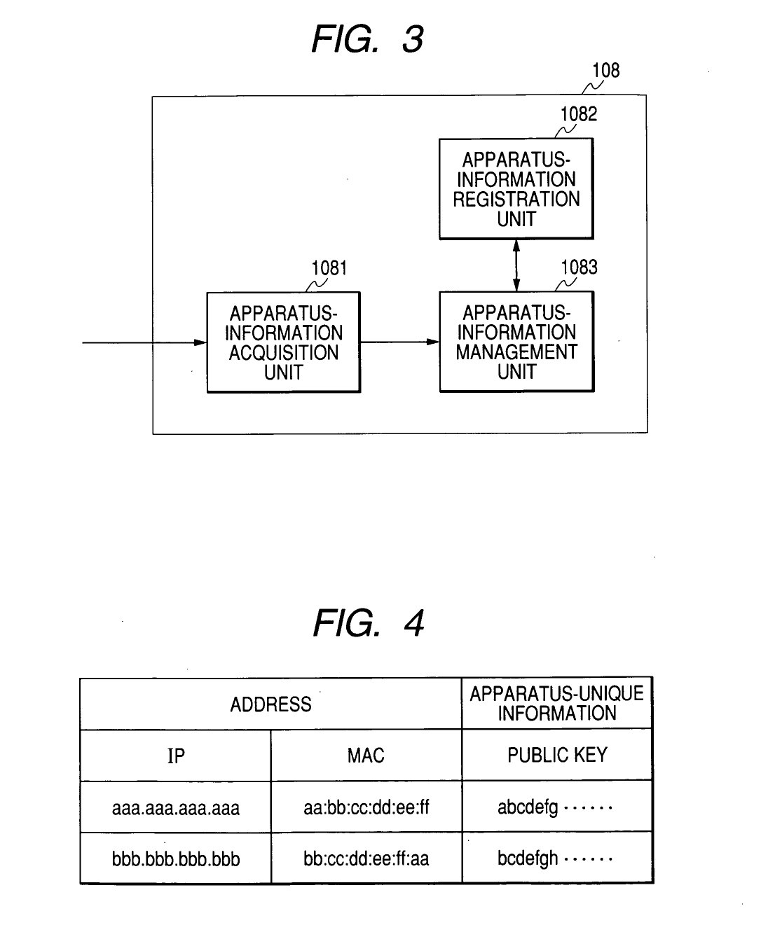

FIG. 3 is a diagram showing the configuration of the apparatus-information registration circuit 108 employed in the content transmission apparatus 100. The following description explains a typical method of, for example, cataloging the address of a content reception apparatus 200 and apparatus information unique to the content reception apparatus 200, which is connected to a network connected to the content transmission apparatus 100.

Reference numeral 1081 denotes an apparatus-inform acquisition unit for acquiring an address and apparatus-unique information from the content reception apparatus 200. Reference numeral 1082 denotes an apparatus-information registration unit for cataloging apparatus-unique information and an address, which have been acquired by the apparatus-information acquisition unit 1081 as apparatus-unique information and address of the content reception apparatus 200. Reference numeral 1083 denotes an apparatus-information management unit for cataloging the content reception apparatus 200 and authenticating the content reception apparatus 200 on the basis of the apparatus information cataloged in the apparatus-information registration unit 1082. The apparatus-information acquisition unit 1081 transmits typically an application for cataloging apparatus information or a web page for cataloging apparatus information through the use of a browser to the content reception apparatus 200.

Receiving the application for cataloging apparatus information or a web page for cataloging apparatus information, the content reception apparatus 200 catalogs the address and apparatus-unique information thereof in the content transmission apparatus 100 in accordance with instructions specified in the application for cataloging apparatus information or the web page for cataloging apparatus information automatically or on the basis of cataloging items entered by the user to the content reception apparatus 200.

An example of the apparatus information unique to the content reception apparatus 200 is a public key generated by a predetermined authentication engine and stored in the non-volatile memory 205 employed in the content reception apparatus 200. Since the public key is stored in the non-volatile memory 205 in advance at a manufacturing time of the content reception apparatus 200, the key has a value unique to the content reception apparatus 200. FIG. 4 is a diagram showing typical public keys cataloged in the apparatus-information registration unit 1082 along with addresses. The address of the content reception apparatus 200 consists of an IP address and a MAC address. On the other hand, a key used as apparatus-unique information is the public key stored in the non-volatile memory 205 employed in the content reception apparatus 200.

As is obvious from the above explanation, in an operation to authenticate a content reception apparatus 200, the content transmission apparatus 100 is capable of identifying a cataloged content reception apparatus 200 on the basis of apparatus information cataloged in the apparatus-information registration circuit 108.

As typical apparatus-unique information, the above description has explained a public key used for mutual authentication when adopting the DTCP for determining a copy protection method in a transmission of a content between a content transmission apparatus and a content reception apparatus, which are connected to each other by a network. However, the apparatus-unique information is not limited specially to the public key. Any information unique to an apparatus can be cataloged as the apparatus-unique information as long as the information can be used for identifying the apparatus.

In addition, even though the above description explains an embodiment adopting a method of cataloging apparatus information of the content reception apparatus 200 in the content transmission apparatus 100, the method can also be applied as a technique of cataloging apparatus information of the content transmission apparatus 100 in the content reception apparatus 200.

Next, a second embodiment of the present invention is explained.

### Second Embodiment

A second embodiment of the present invention is explained as follows.

This embodiment is characterized in that it is possible to provide a content transmission apparatus and a content reception apparatus, which are capable of implementing copy protection to avoid illegal copies of a content transmitted by way of a wire or wireless LAN and capable of limiting legal operations to watch a content and make copies of the content to a range of personal use of the content.

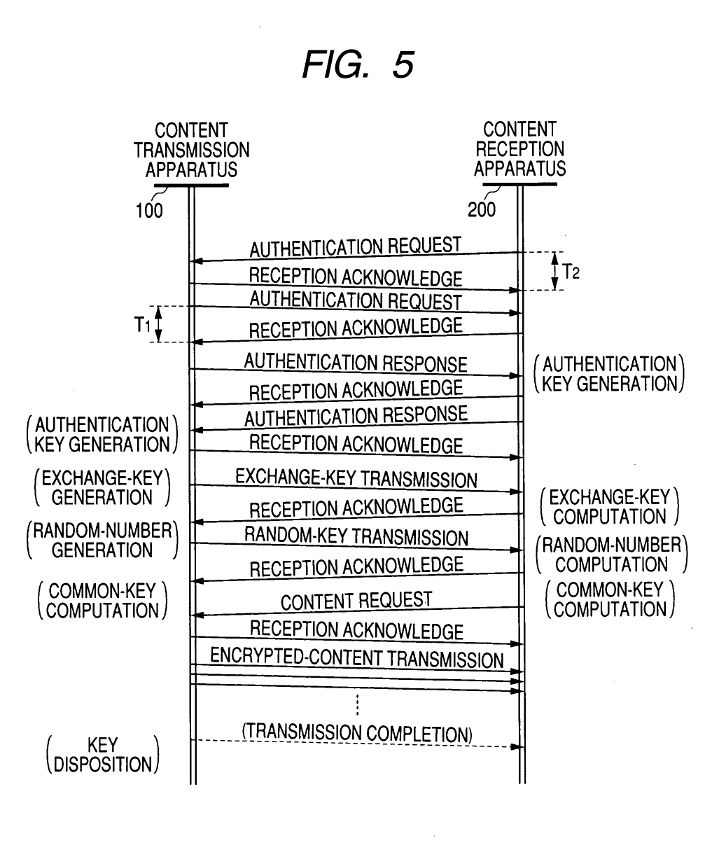

FIG. 5 is a diagram showing a typical procedure for transmitting a content from a content transmission apparatus 100 to a content reception apparatus 200. A vertical line at the left end represents the content transmission apparatus 100 whereas a vertical line at the right end represents the content reception apparatus 200. Each arrow expresses the timing and direction of a transmission or reception of the apparatus.

First of all, the content reception apparatus 200 creates an authentication request. The authentication request specifies a public key serving as the apparatus-unique information described earlier and includes a certificate of the public key. The authentication request is then transmitted to the content transmission apparatus 100. Receiving the authentication request, the content transmission apparatus 100 transmits an acknowledgement of the reception of the authentication request to the content reception apparatus 200. Then, the content transmission apparatus 100 creates its own authentication request for authenticating the content reception apparatus 200. Much like the authentication request created by the content reception apparatus 200, the authentication request created by the content transmission apparatus 100 specifies a public key issued by an authentication engine as a public key unique to the content transmission apparatus 100 and includes a certificate of the public key. The content transmission apparatus 100 then transmits the authentication request to the content reception apparatus 200. At the same time, the content transmission apparatus 100 drives the timer circuit 107 to start its operation to measure a time interval T1 between the transmission of the authentication request and a reception of an acknowledgement of a reception of a response to the request from the content reception apparatus 200.

If the time interval T1 does not exceed a predetermined value T, that is, if T1<T, the content reception apparatus 200 is authenticated to be an apparatus existing in a range of personal use. The operation to authenticate an apparatus to be an apparatus existing in a range of personal use is referred to as a time authentication. Reversely, a time authentication for the content transmission apparatus 100 can be carried out by transmitting an authentication request from the content reception apparatus 200 to the content transmission apparatus 100, driving the timer circuit 207 to start its operation to measure a time interval T2 between the transmission of the authentication request and a reception of an acknowledgement of a reception of a response to the request from the content transmission apparatus 100.

If the mutual authentications described above are successful, an authentication key common to the content transmission apparatus 100 and the content reception apparatus 200 is generated as a key to be shared by the apparatus. A commonly known key exchange algorithm is normally adopted in generating the authentication key. As the process of sharing the authentication key is completed, the content transmission apparatus 100 generates an exchange key and a random number, encrypts the exchange key and the random number by using the authentication key and transmits the encrypted exchange key and the encrypted random number to the content reception apparatus 200. It is to be noted that, even though the content transmission apparatus 100 transmits the encrypted exchange key and the encrypted random number to the content reception apparatus 200 separately in accordance with the procedure shown in FIG. 5, the content transmission apparatus 100 can also transmit the encrypted exchange key and the encrypted random number to the content reception apparatus 200 as single data.

Then, the content reception apparatus 200 uses the authentication key to decrypt the encrypted exchange key and the encrypted random number, which have been received from the content transmission apparatus 100, storing the exchange key and the random number in a memory.

Subsequently, the content transmission apparatus 100 and the content reception apparatus 200 each use the exchange key and the random number to generate a common key in accordance with a computation algorithm determined in advance. As will be described below, the common key generated in this way is a key used by the content transmission apparatus 100 to encrypt a content to be transmitted to the content reception apparatus 200 and the content reception apparatus 200 is capable of decrypting the encrypted content received from the content transmission apparatus 100.

If the aforementioned authentications between the content transmission apparatus 100 and the content reception apparatus 200 are successful, the content reception apparatus 200 transmits a request to the content transmission apparatus 100 as a request for a transmission of a content. At this request, the content transmission apparatus 100 encrypts a content and transmits the encrypted content to the content reception apparatus 200. As the requested transmission of the content is completed, the content transmission apparatus 100 destroys the authentication key, the exchange key and the common key required for encrypting the content and decrypting the encrypted content. In the content reception apparatus 200, the authentication key, the exchange key and the common key are destroyed as is the case with the transmission apparatus 100, and when it is necessary to again receive a content, a new authentication request is normally made. In the case of this embodiment of the present invention, however, when the content reception apparatus 200 passes the time authentication, the address information of the content reception apparatus 200 and the apparatus information unique to the content reception apparatus 200 are stored in the apparatus-information registration circuit 108 of the content transmission apparatus 100 as described above.

Thus, by saving the common key common to the content transmission apparatus 100 and the content reception apparatus 200 cataloged in the apparatus-information registration circuit 108 of the content transmission apparatus 100 instead of destroying it, it is not necessary to transmit an authentication request to the content reception apparatus 200 in order to again transmit a content.

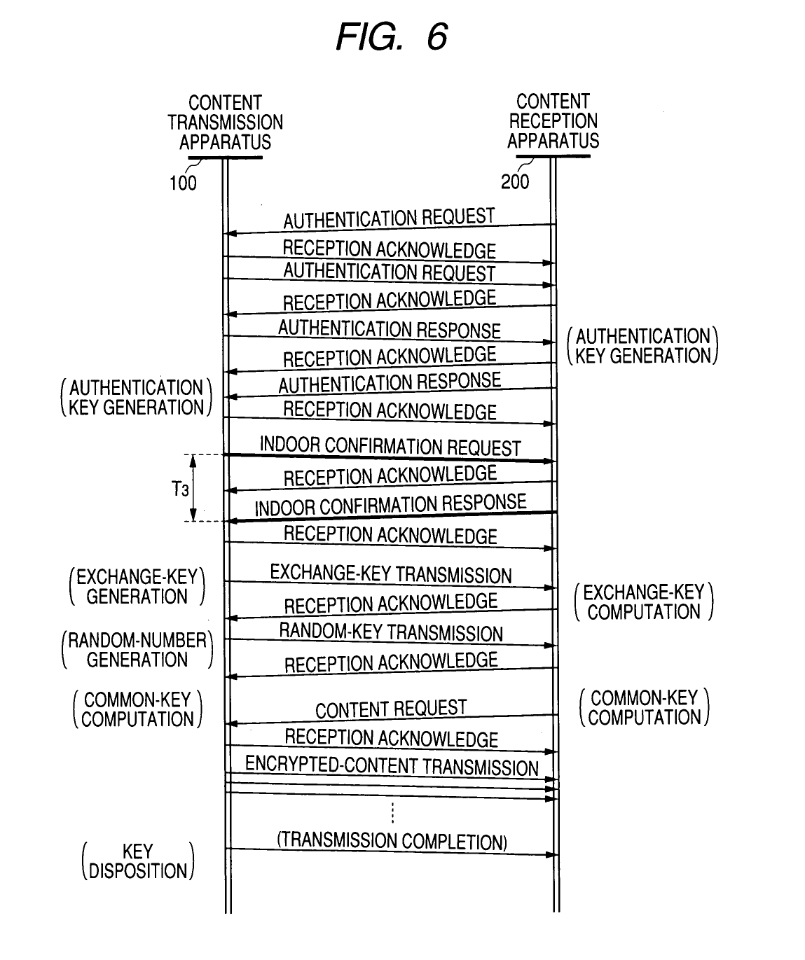

FIG. 6 is a diagram showing a procedure for measuring a time interval securely and accurately in the time-authentication process. As shown in FIG. 6, if the mutual authentications carried out between the content transmission apparatus 100 and the content reception apparatus 200 are successful, the content transmission apparatus 100 transmits an in-house confirmation request to the content reception apparatus 200 and, at the same time, drives the timer circuit 107 to start its operation.

After transmitting an acknowledgement to the content transmission apparatus 100 as an acknowledgement of a reception of the in-house confirmation request received from the content transmission apparatus 100, the content reception apparatus 200 transmits an in-house confirmation response. The content transmission apparatus 100 measures a time interval T3 between the transmission of the in-house confirmation request and a reception of the in-house confirmation response from the content reception apparatus 200. If the time interval T3 does not exceed a predetermined value, the content reception apparatus 200 is authenticated to be a reception apparatus existing at the same home as the content transmission apparatus 100. After inter-apparatus authentications are carried out mutually by the content transmission apparatus 100 and the content reception apparatus 200 in this way, the time authentications described above can be performed securely and accurately.

The protocol adopted in transmitting a content from the content transmission apparatus 100 to the content reception apparatus 200 is not limited to the specific one. Protocols adoptable in such transmission include an RTP (Real-Time Transport Protocol), an HTTP (Hyper Text Transfer Protocol) and an FTP (File Transfer Protocol). In a transmission of a content, the content is encrypted by using a common key in accordance with an encryption algorithm determined in advance and accommodated in a payload portion of a transfer protocol used in the transmission. As a typical encryption algorithm, it is possible to adopt an AES (Advanced Encryption Standard) algorithm, which is an algorithm of a widely known encryption technology.

As described above, in the second embodiment, the content transmission apparatus catalogs the address of a content reception apparatus, which has been authenticated by the content transmission apparatus, and the apparatus information unique to the content reception apparatus. Thus, in a transmission of another content to the content reception apparatus, the other content is merely encrypted without the need to carry out a time authentication on the content reception apparatus. That is to say, the time authentication that used to be carried out for each content reception can be eliminated.

### Third Embodiment

Next, a third embodiment of the present invention is explained.

In accordance with the third embodiment of the present invention, for example, a portable terminal can be used to watch a content, which is transmitted from the content transmission apparatus 100, through the Internet.

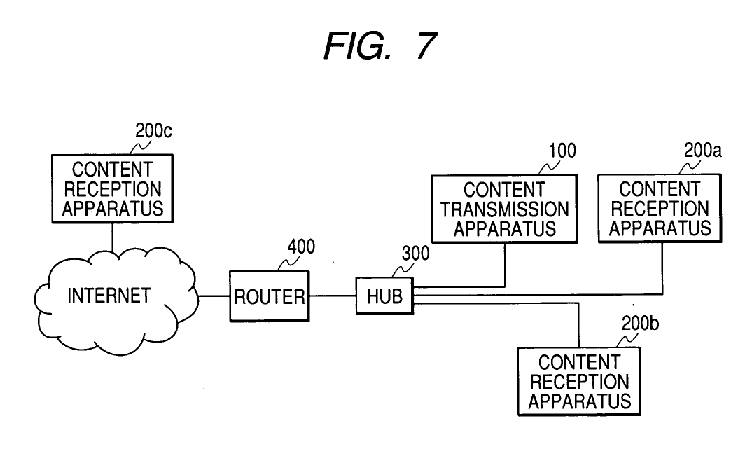

FIG. 7 is a diagram showing a configuration in which a content is watched through the Internet. Reference numeral 200c denotes a portable content reception apparatus, which has once passed a time authentication carried out by the content transmission apparatus 100. Naturally, the portable content reception apparatus 200c, which is now connected to the Internet, cannot be used to watch a content transmitted from the content transmission apparatus 100 because a time authentication carried out by the content transmission apparatus 100 gives a result of (T1>T), which is an unsuccessful authentication. In accordance with the present invention, since the portable content reception apparatus 200c has once passed a time authentication carried out by the content transmission apparatus 100, however, the content transmission apparatus 100 has cataloged the address of the portable content reception apparatus 200c and the public key serving as the apparatus information unique to the content reception apparatus 200c in the apparatus-information registration circuit 108.

Thus, even at a location where the relation T1>T holds true, the portable content reception apparatus 200c cataloged in the apparatus-information registration circuit 108 can be used to receive and watch a content transmitted from the content transmission apparatus 100 without the need to carry out a time authentication. In addition, apparatus that can be used to receive and watch a content transmitted from the content transmission apparatus 100 are limited to apparatus cataloged in the apparatus-information registration circuit 108. Thus, it is possible to implement copy protection for avoiding illegal copies of the content and to limit operations to legally watch the content and create legal copies of the content to a range of personal use.

In addition, a TCP packet is used for transmitting an authentication request, an authentication response indicating a result of the requested authentication and a content. In this case, a TTL (Time To Live) of the TCP packet or a transmitted IP packet accommodating a UDP data gram is set at a low value of typically 1 so that an authentication request will not pass through the router 400. In this way, it is possible to add a limitation for limiting the transmission of a packet to a range of personal use.

### Fourth Embodiment

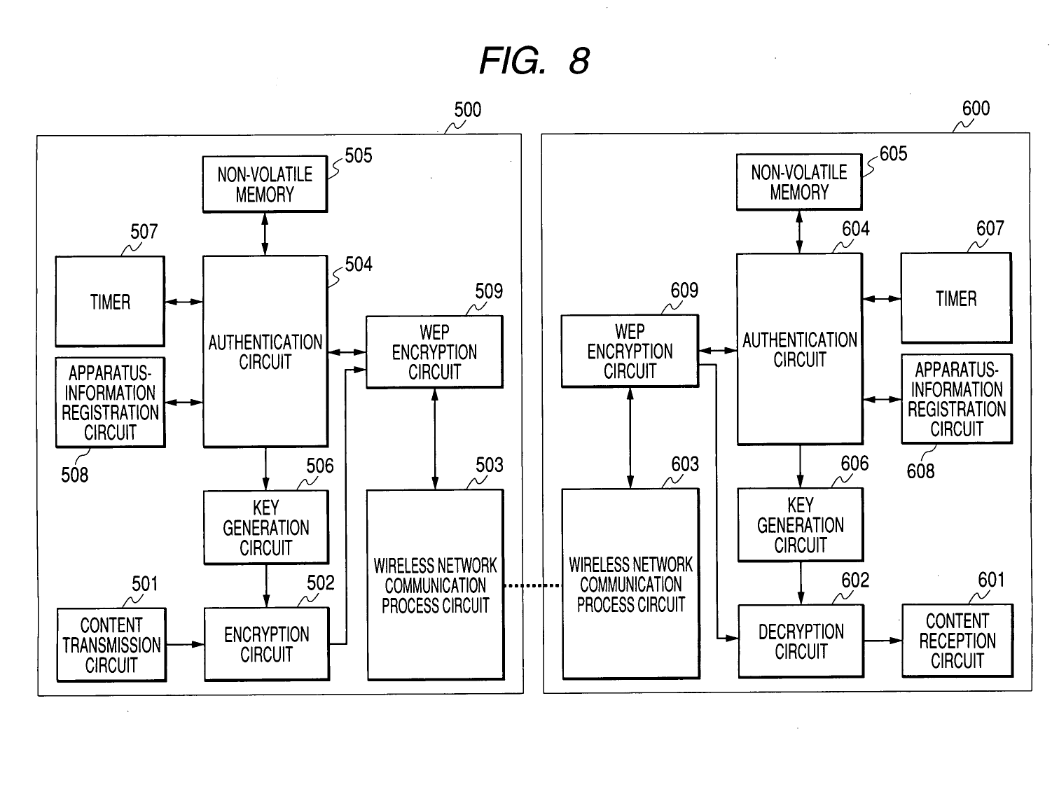

A fourth embodiment implements a content transmission apparatus 500 for transmitting a content by way of a wireless LAN and a content reception apparatus 600 for receiving the content. FIG. 8 is a diagram showing the content transmission apparatus 500 transmitting a content by way of a wireless LAN and the content reception apparatus 600 receiving the content. The content transmission apparatus 500 and the content reception apparatus 600 are connected to the wireless LAN by a wireless network communication process circuit 503 and a wireless network communication process circuit 603 respectively. The content transmission apparatus 500 and the content reception apparatus 600 include WEP (Wired Equivalent Privacy) encryption circuits 509 and 609 respectively. A WEP technique is an encryption method commonly known as an industry standard set for the purpose of security protection in a wireless LAN. The WEP method allows communications with security protection to be implemented between reception and transmission apparatus under management executed by the user.

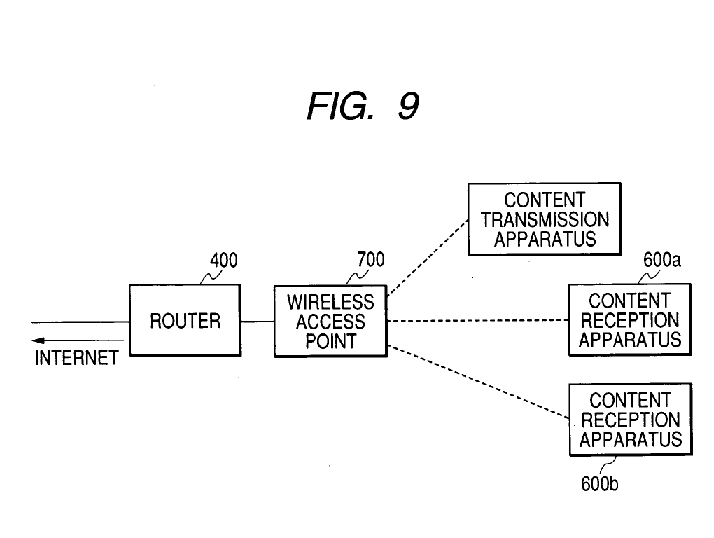

FIG. 9 is a diagram showing the configuration of a network installed inside a home as a network for connecting the content transmission apparatus 500 and content reception apparatus 600 to each other. In the configuration shown in FIG. 9, the content transmission apparatus 500 and two content reception apparatus, namely, the content reception apparatus 600a and the content reception apparatus 600b , are connected to the wireless LAN by a wireless access point 700, which is further connected to a router 400. Much like the router 400 shown in FIG. 2, this router 400 is connected to the Internet.

Prior to mutual authentications between the content transmission apparatus 500 and the content reception apparatus 600, which are shown in FIG. 8, and a process following the mutual authentications to transmit a content from the content transmission apparatus 500 and receive the content in the content reception apparatus 600, authentication circuits 504 and 604 check whether or not WEP processing has been carried out in the WEP encryption circuit 509 and the WEP encryption circuit 609 respectively. If no WEP processing has been carried out, a process is carried out in order to prevent the mutual authentications and the subsequent processing to transmit a content from being performed or in order to typically display a message requesting the user to activate the WEP processing.

As described above, before a content is transmitted through the wireless LAN, the WEP processing is always carried out. As a result, it is possible to prevent a content from being illegally copied by another data reception apparatus, which is connected to the wireless LAN without awareness of the users of the content transmission apparatus 500 and the content reception apparatus 600.

Aspects other than what is described above are exactly the same as those of the content transmission methods adopted by the content transmission apparatus and the content reception apparatus, which are implemented by the first to third embodiments. Thus, it is possible to protect copyrights of contents by suppressing creations of illegal copies of the contents. As a result, it is possible to prevent a content from being transmitted beyond a range of personal use.

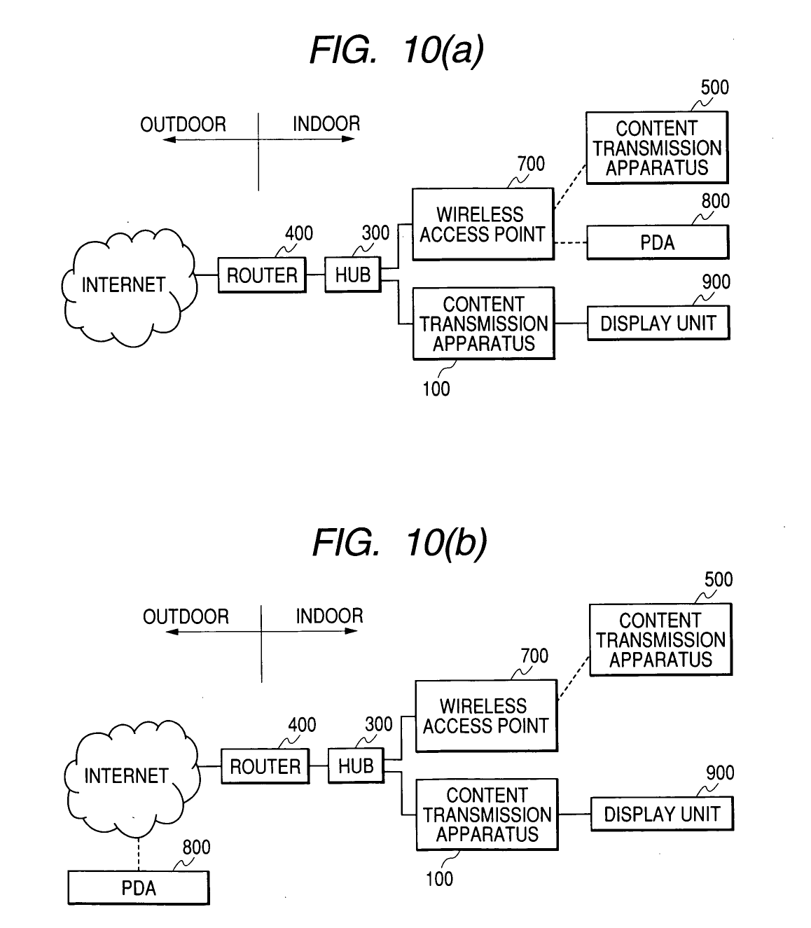

FIG. 10 is a diagram showing a typical configuration including a PDA (Personal Digital Assistance) implemented by an embodiment of the present invention. To be more specific, FIG. 10A shows a connection for carrying out authentications between the PDA 800 and content transmission apparatus 100 and 500. On the other hand, FIG. 10B shows a configuration in which a content transmitted by the content transmission apparatus 100 or the content transmission apparatus 500 is watched at a location outside the home by using the PDA 800. The PDA 800 can be used to watch a content transmitted by the content transmission apparatus 100 or the content transmission apparatus 500. Reference numeral 900 denotes a display unit installed inside the home as a display unit used by the user to watch a content transmitted by the content transmission apparatus 100 or the content transmission apparatus 500. Examples of the display unit 900 are a plasma display unit and a liquid-crystal display unit.

For example, the purchased PDA 800 is connected to the LAN inside the home and authentications with the content transmission apparatus 100 as well as the content transmission apparatus 500 are carried out. If the authentications carried out by the content transmission apparatus 100 and 500 are successful, the content transmission apparatus 100 and 500 catalog the address of the PDA 800 and a common key, which is used as apparatus information unique to the PDA 800, for apparatus-management purposes. Without cataloging the information relevant to the PDA 800, the PDA 800 used at a location outside the home would naturally be disallowed by a time authentication to receive a content transmitted by any of the content transmission apparatus 100 and 500, which are installed at locations inside the home. In accordance with the present invention, however, once the PDA 800 passed the time authentications carried out by the content transmission apparatus 100 and 500, the apparatus information of the PDA 800 is cataloged in the content transmission apparatus 100 and 500 so that the PDA 800 can be used for watching a content transmitted by any of the content transmission apparatus 100 and 500, which are installed at locations inside the home.

As described above, in accordance with the embodiments of the present invention, the content transmission apparatus authenticates a content reception apparatus at a request for an authentication and catalogs the address of the content reception apparatus as well as apparatus information unique to the content reception apparatus. Thus, it is possible to provide a content transmission apparatus and a content reception apparatus that are capable of implementing copy protection to avoid an illegal copy of a content when the content is transmitted from the content transmission apparatus to the content reception apparatus by way of a wire or wireless LAN and, in addition, also capable of limiting legal operations of watching a content and making copies of the content to a range of personal use of the content. In addition, it is needless to say that, by having the content reception apparatus authenticate the content transmission apparatus and catalog the address of the content transmission apparatus as well as apparatus information unique to the content transmission apparatus, the same effect can also be obtained. In addition, even though information transmitted through the network is a content such as image information and apparatus transmitting and receiving the content are a content transmission apparatus and a content reception apparatus respectively as described above, the present invention can of course be applied to information of a kind other than the image information and information-processing apparatus for outputting and inputting the information.

The present invention is capable of implementing copy protection to avoid an illegal copy of a content when the content is transmitted from the content transmission apparatus to the content reception apparatus by way of a wire or wireless LAN and, in addition, also capable of limiting legal operations of watching a content and making copies of the content to a range of personal use of the content.

1. A content transmission apparatus comprising:
a network communication process means for transmitting and receiving data by way of a network;
a transmission-content generation means for supplying a content to be transmitted to a content reception apparatus, which is connected to said content transmission apparatus through said network, to said network communication process means;
an authentication means for receiving an authentication request from said content reception apparatus, carrying out an authentication determination for said received authentication request and issuing its own authentication request to said content reception apparatus;
an encryption means for generating a key based on information produced by said authentication means as a result of execution of an authentication process in said authentication means and encrypting a content to be transmitted to said content reception apparatus by using said key;
a timer means used if necessary for measuring a time interval between a transmission of its own authentication request to said content reception apparatus and a reception of an acknowledgement of a reception of said authentication request from said content reception apparatus or between a transmission of a response to an authentication request received from said content reception apparatus to said content reception apparatus and a reception of an acknowledgement of a reception of said response from said content reception apparatus; and
an apparatus-information management means for cataloging and managing apparatus information of said content reception apparatus;
wherein said apparatus-information management means controls operations to catalog the address of said content reception apparatus and apparatus information stored in advance at an apparatus-manufacturing time as information unique to said content reception apparatus in dependence on a measurement result produced by said timer means.

2. A content transmission apparatus according to claim 1 wherein, if a measurement result produced by said timer means does not exceed a predetermined value in said timer means, said address of said content reception apparatus and said apparatus information unique to said content reception apparatus are stored in said apparatus-information management means.

3. A content transmission apparatus according to claim 1 wherein, when a request for a content is received from said content reception apparatus, an address and apparatus-unique information, which have been cataloged in said apparatus-information management means, are compared with said address of said content reception apparatus and apparatus information unique to said content reception apparatus respectively and, if they match each other, said requested content is transmitted to said content reception apparatus without driving said timer means to measure a time interval.

4. A content reception apparatus comprising:
a network communication process means for transmitting and receiving data by way of a network;
a content reception process means for receiving a content from said network communication process means receiving said content from a content transmission apparatus connected to said content reception apparatus through said network;
an authentication means for issuing an authentication request to said content transmission means and carrying out an authentication determination for an authentication request received from said content transmission apparatus;
an encryption means for generating a key based on information produced by said authentication means as a result of execution of an authentication process in said authentication means and decrypting a content received from said content transmission apparatus by using said key;
a timer means used if necessary for measuring a time interval between a transmission of an authentication request to said content transmission apparatus and a reception of an acknowledgement of a reception of said authentication request from said content transmission apparatus or between a transmission of a response to an authentication request received from said content transmission apparatus to said content reception apparatus and a reception of an acknowledgement of a reception of said response from said content transmission apparatus; and
an apparatus-information management means for cataloging and managing apparatus information of said content transmission apparatus;
wherein said apparatus-information management means controls operations to catalog the address of said content transmission means and apparatus information stored in advance at an apparatus-manufacturing time as information unique to said content transmission apparatus in dependence on a measurement result produced by said timer means.

5. A content reception apparatus according to claim 4 wherein, if a measurement result produced by said timer means does not exceed a predetermined value in said timer means, said address of said content transmission apparatus and said apparatus information unique to said content transmission apparatus are stored in said apparatus-information management means.

6. A content reception apparatus according to claim 4 wherein, when a request for a reception of a content is received from said content transmission apparatus, an address and apparatus-unique information, which have been cataloged in said apparatus-information management means, are compared with said address of said content transmission apparatus and apparatus information unique to said content transmission apparatus respectively and, if they match each other, said requested content is received from said content reception apparatus without driving said timer means to measure a time interval.

7. A content transmission apparatus comprising:
an authentication means for receiving an authentication request from a content reception apparatus connected to said content transmission apparatus by a network, carrying out an authentication determination for said received authentication request and issuing its own authentication request to said content reception apparatus in a process to transmit a content to said content reception apparatus;
a timer means used if necessary for measuring a time interval between a transmission of its own authentication request to said content reception apparatus and a reception of an acknowledgement of a reception of said authentication request from said content reception apparatus or between a transmission of a response to an authentication request received from said content reception apparatus to said content reception apparatus and a reception of an acknowledgement of a reception of said response from said content reception apparatus; and
an apparatus-information management means for cataloging and managing apparatus information of said content reception apparatus;
wherein said apparatus-information management means catalogs the address of said content reception apparatus and apparatus information unique to said content reception apparatus if a measurement result produced by said timer means does not exceed a predetermined value.

8. A content transmission apparatus according to claim 7 wherein, when a request for a content is received from said content reception apparatus, an address and apparatus-unique information, which have been cataloged in said apparatus-information management means, are compared with said address of said content reception apparatus and apparatus information unique to said content reception apparatus respectively and, if they match each other, said requested content is transmitted to said content reception apparatus without driving said timer means to measure a time interval.

9. A content reception apparatus comprising:
an authentication means for receiving an authentication request from a content transmission apparatus connected to said content reception apparatus by a network, carrying out an authentication determination for said received authentication request and issuing its own authentication request to said content transmission apparatus in a process to receive a content from said content transmission apparatus;
a timer means used if necessary for measuring a time interval between a transmission of its own authentication request to said content transmission apparatus and a reception of an acknowledgement of a reception of said authentication request from said transmission reception apparatus or between a transmission of a response to an authentication request received from said content transmission apparatus to said content transmission apparatus and a reception of an acknowledgement of a reception of said response from said content transmission apparatus; and
an apparatus-information management means for cataloging and managing apparatus information of said content transmission apparatus;
wherein said apparatus-information management means catalogs the address of said content transmission apparatus and apparatus information unique to said content transmission apparatus if a measurement result produced by said timer means does not exceed a predetermined value.

10. A content reception apparatus according to claim 9 wherein, when a request for a reception of a content is received from said content transmission apparatus, an address and apparatus-unique information, which have been cataloged in said apparatus-information management means, are compared with said address of said content transmission apparatus and apparatus information unique to said content transmission apparatus respectively and, if they match each other, said requested content is received from said content transmission apparatus without driving said timer means to measure a time interval.

11. An information-processing apparatus comprising:
an authentication means for receiving an authentication request from another information-processing apparatus connected to said information-processing apparatus by a network, carrying out an authentication determination for said received authentication request and issuing its own authentication request to said other information-processing apparatus in a process to output information to said other information-processing apparatus;
a time-interval measurement means used if necessary for measuring a time interval between a transmission of its own authentication request to said other information-processing apparatus and a reception of an acknowledgement of a reception of said authentication request from said other information-processing apparatus or between a transmission of a response to an authentication request received from said other information-processing apparatus to said other information-processing apparatus and a reception of an acknowledgement of a reception of said response from said other information-processing apparatus; and
an apparatus-information management means for cataloging and managing apparatus information of said other information-processing apparatus;
wherein said apparatus-information management means catalogs the address of said other information-processing apparatus and apparatus information unique to said other information-processing apparatus if a measurement result produced by said time-interval measurement means does not exceed a predetermined value.

12. An information-processing apparatus according to claim 11 wherein, when a request for information is received from said other information-processing apparatus, an address and apparatus-unique information, which have been cataloged in said apparatus-information management means, are compared with said address of said other information-ping apparatus and apparatus information unique to said other information-processing apparatus respectively and, if they match each other, said requested information is transmitted to said other information-processing apparatus without driving said time-interval measurement means to measure a time interval.
